(19) United States
(12) Patent Application Publication
(10) Pub. No.: US 2026/0117599 A1
(43) Pub. Date: Apr. 30, 2026

(54) INTERVENTION TOOL WET CONNECTION

(71) Applicant: Schlumberger Technology Corporation, Sugar Land, TX (US)

(72) Inventors: Andrew Mueller, Sugar Land, TX (US); Kamalah Chang, Taubate (BR); Jon Turner, Barrow-in-Furness (GB); Eric Chaize, Barrow in Furness (GB); Ricardo Barreto Pereira, Taubate (BR)

(21) Appl. No.: 19/376,071

(22) Filed: Oct. 31, 2025

Related U.S. Application Data
(60) Provisional application No. 63/714,334, filed on Oct. 31, 2024.

(51) Int. Cl. E21B 17/02; E21B 47/12

(52) U.S. Cl. CPC E21B 17/028; E21B 47/12

(57) ABSTRACT

Embodiments presented provide for a wireline tool connection. In embodiments, a wellbore intervention tool wet connection and method of connecting an intervention tool are presented for quickly performing field connections, preventing short circuiting and tool damage.

### CROSS-REFERENCE TO RELATED APPLICATIONS

The present application claims priority to U.S. Provisional Application 63,714,334 dated Oct. 31, 2024, the entirety of which is incorporated by reference.

### FIELD OF THE DISCLOSURE

Aspects of the disclosure relate to wireline tool configurations. More specifically, aspects of the disclosure relate to connection arrangements for wireline tool configurations.

### BACKGROUND

Wireline tools are essential instruments deployed by oil field service companies to perform a wide array of wellbore functions with efficiency and precision. These tools are typically lowered into the wellbore on an electrically conductive cable, known as wireline, which allows for both mechanical manipulation and real-time data transmission between the surface and downhole environments. Wireline operations are integral to the lifecycle of a well, supporting activities such as logging, perforating, setting plugs, retrieving devices, and conducting diagnostic tests. Each tool is engineered to fulfill a specific function, and their deployment is carefully coordinated to optimize well performance and ensure operational safety.

One of the primary wireline tool functions is formation evaluation, achieved through logging tools that measure properties such as resistivity, porosity, and sonic velocity of the surrounding rock. These measurements provide critical data for reservoir characterization and production planning. Another important function is wellbore intervention, where wireline-conveyed devices like plugs, packers, and perforating guns are positioned to control fluid flow or stimulate production. Additionally, wireline tools are used for mechanical retrieval operations, such as fishing lost equipment or debris from the wellbore, and for setting or removing downhole valves and sleeves. The versatility of wireline tools makes them indispensable for routine maintenance, troubleshooting, and enhancement of well productivity.

In practice, wireline tools are rarely deployed individually. Instead, multiple tools are often assembled into a tool string, which allows several operations to be performed in a single run. A typical tool string might include a logging tool, a centralizer, a perforating gun, and a telemetry module, all connected in series by specialized connectors. The modularity of tool strings offers significant advantages in terms of operational flexibility and time savings, as it reduces the need for multiple trips in and out of the well. However, this interconnected arrangement introduces a range of technical challenges, particularly at the points where tools are joined together.

Tool connections within wireline strings are critical to the success of wellbore operations, yet they are a frequent source of problems in the field. Electrical shorts are a common issue, often resulting from compromised insulation or misaligned connectors. When an electrical short occurs, it can disrupt data transmission, interfere with tool operation, and potentially damage sensitive electronics. Mechanical damage is another prevalent problem, arising from improper assembly, excessive torque, or impact during handling and deployment. Damaged connectors may lead to tool failure, loss of integrity, or increased risk of stuck tools, all of which can significantly delay operations and increase costs.

Field operations involving wireline tool connections are often time-consuming and require a high degree of skill and attention to detail. Technicians must ensure that each connector is properly mated, tested for continuity, and verified for mechanical integrity before deployment. Environmental conditions such as temperature extremes, humidity, and the presence of well fluids can further complicate the connection process. In some cases, tools must be disassembled, cleaned, and reconnected multiple times to resolve persistent issues, leading to extended non-productive time and operational frustration. The reliance on conventional connector technologies, many of which have changed little over decades, exacerbates these challenges and highlights the limitations of current field practices.

The need for improved wireline field connections is evident when considering the demands of modern oilfield operations. Enhanced connector designs that offer robust electrical isolation, greater mechanical strength, and simplified assembly procedures could dramatically reduce the incidence of electrical shorts and mechanical failures. Innovations such as self-aligning connectors, integrated diagnostic features, and tool-less assembly mechanisms have the potential to streamline field operations and minimize human error. By addressing the shortcomings of conventional technologies, the industry can improve operational reliability, reduce downtime, and lower the overall cost of wellbore interventions. These advancements are essential for meeting the evolving challenges of complex wells and maximizing the value derived from wireline-enabled activities.

There is a need to provide an apparatus and methods that easier to operate than conventional apparatus and methods.

There is a further need to provide apparatus and methods that do not have the drawbacks discussed above.

There is a still further need to reduce economic costs associated with operations and apparatus described above with conventional tools.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a method for performing a wet connection in a downhole environment is disclosed. The method may comprise placing a second half of an arrangement in the downhole environment. The method may further comprise lowering a first half of the arrangement in the downhole environment. The method may further comprise aligning at least one pin of at least one of the first half of the arrangement and the second half of the arrangement with an alignment connection. The method may further comprise inserting the at least one pin into the alignment connection, wherein during the inserting pins from the second half of the arrangement are inserted into the first half of the arrangement and wherein an inner sleeve pin of the first half of the arrangement accepts the pins. The method may further comprise activating a motor such that locking dogs connect the first half of the arrangement and the second half of the arrangement, wherein locking dog ends interface with a movable sleeve. The method may further comprise activating a control unit such that electrical energy is transferred between the first half of the arrangement and the second half of the arrangement.

In another example embodiment, a method for performing a wet connection in a downhole environment is disclosed. The method may comprise placing a second half of an arrangement in the downhole environment. The method may further comprise lowering a first half of the arrangement in the downhole environment. The method may further comprise aligning at least one pin of at least one of the first half of the arrangement and the second half of the arrangement with an alignment connection. The method may further comprise inserting the at least one pin into the alignment connection, wherein during the inserting pins from the second half of the arrangement are inserted into the first half of the arrangement and wherein an inner sleeve pin of the first half of the arrangement accepts the pins. The method may further comprise activating a motor such that locking dogs connect the first half of the arrangement and the second half of the arrangement, wherein locking dog ends interface with a movable sleeve. The method may further comprise extending the locking dogs from a disengaged position to an engaged position. The method may further comprise sending a signal from the downhole environment to the up-hole environment that a successful connection has been established. The method may further comprise activating a control unit such that electrical energy is transferred between the first half of the arrangement and the second half of the arrangement.

In another example embodiment, a connection for a downhole environment is disclosed. The connection comprises a first section having a first electrical socket. The connection further comprises a second section, having a motor and a set of latching dogs, the set of latching dogs configured to move from an engaged position to a disengaged position upon actuation by the motor, further having a collar that is configured to slide from a first position to a second position and a second electrical plug configured to engage with the first electrical socket to transfer electrical power through the connection.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted, however, that the appended drawings illustrate only typical embodiments of this disclosure and are therefore not be considered limiting of its scope, for the disclosure may admit to other equally effective embodiments.

FIG. 1 is an exploded view of an embodiment of a connector. In one or more embodiments, a connector may comprise a single pin having radial contacts for facilitating electrical connection with a reciprocating connector of a wireline tool, the single pin being housed in a housing. In a further embodiment, the connector may comprise more than one of the single pin arrangements for a multipin arrangement for achieving a higher number of electrical contacts.

FIG. 2 illustrates a sectional view of an embodiment of the connector with a multipin with a multipin configuration. In one or more embodiments, the connector may further comprise sealing plates and barrier fluid compensations for sealing the housing from fluids.

FIG. 3 is a sectional view of a single pin of an embodiment of a connector. In one or more embodiments, the single pin of the connector may comprise radial alignment features to facilitate autonomous tool makeup.

FIG. 4 is one example method of an embodiment of the disclosure, wherein a first and second section of an arrangement are connected in a wet environment.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, components, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When an element or layer is referred to as being “on.” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

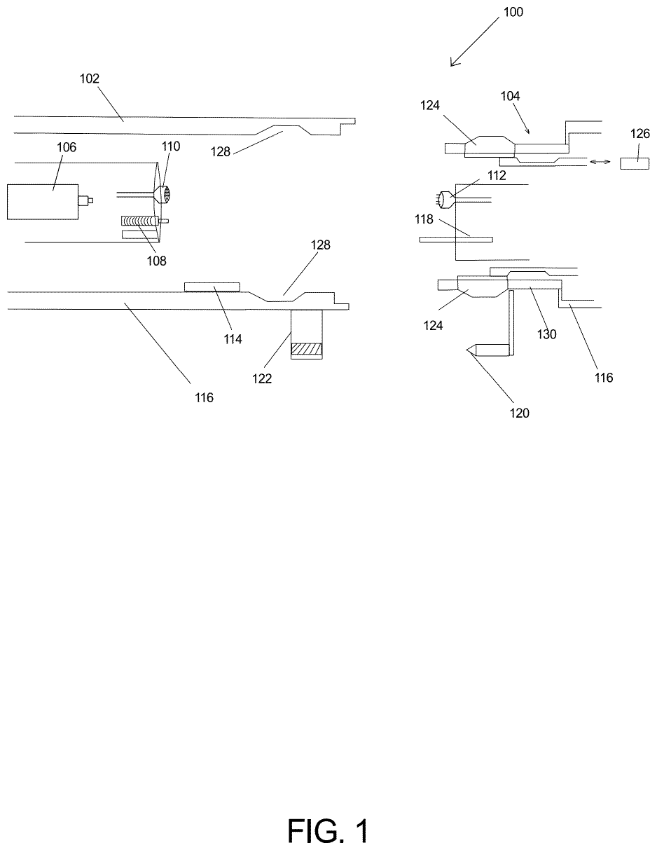

Referring to FIG. 1, an intervention tool wet connection apparatus 100 is illustrated. The apparatus 100 comprises a first section 102 that is to be joined to a second section 104. For description, the left most side of FIG. 1 refers to an up-hole tool in a tool string that is to be investigated/worked upon. The right most side of FIG. 1 refers to the down-hole tool in the tool string. Embodiments described for the wet connection apparatus 100 allow for connections to be made within the downhole environment or in an up-hole environment. The apparatus 100 described allow for more fault tolerance and protection from unintended wet conditions, such as rain at the surface, shorting out electrical components. Such more robust connections add significant value to field operations preventing transportation of alternative tools to the wellsite in the instance of damage to tool components in the up-hole or downhole environments.

Controls 106 are provided in the up-hole section of the tool string. These controls 106 are provided to energize electrical components between the first section 102 and the second section 104 upon successful connection between the first section 102 and the second section 104. As a precaution, the controls 106 may only send electrical power/energy through the first section 102 to the second section 104 upon a signal received in the up-hole environment.

In the absence of tool make-up confirmation, the electrical energy/power is prevented from flowing by the controls 106 to prevent short circuiting in the apparatus 100 and possible damage. A tool make up confirmation arrangement 108 may be located in the first section 102 such that upon successful connection of the first section socket 110 to the second end plug 112, the circuit is energized and the needed signal.

Within the first section 102 that is formed as a hollow pipe or tube, an inner sleeve 114 is provided. The inner sleeve 114 is attached to the body 116 of the apparatus. The inner sleeve 114 is provided with a pin guide profile 118 wherein pins from the second end plug 112 may be channeled through the pin guide profile 118 and into the first section socket 110. In the illustrated embodiment, the second end plug 112 is provided with male ends that mate with female ends of the first section socket 110. As illustrated, the inner sleeve 114 may be configured as a conical arrangement to ensure that the correct pins of the second end plug 112 are routed to the corresponding female ends in the first section socket 110.

An external alignment pin 120 is provided to allow for aligning the first section 102 to the second section 104. Upon successful insertion of the alignment pin 120 of the second section 104 to the corresponding alignment arrangement 122 in the first section 102, further insertion of the second section 104 into the first section 102.

A set of locking dogs 124 are provided in the second section 104. The purpose of the set of locking dogs 124 is to extend from a disengaged position to an engaged position. In the engaged position, the second section 104 is captured into first section 102. The set of locking dogs 124 are controlled by a motor 126 in the down hole tool wherein the set of locking dogs 124 are connected to a movable sleeve 130. As will be understood, the motor 126 may be energized by a downhole battery system present within the second section 104. In this engaged position, the tangs 126 with the set of locking dogs 124 fit into corresponding recesses 128 present in the first section 102.

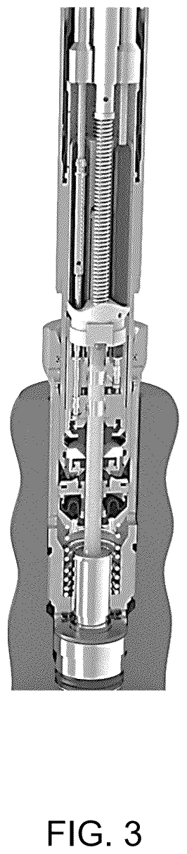

In an alternative configuration, the motor 126 may be positioned within the first section 102 as well as the movable sleeve 130 such that the tangs 126 extend from the first section 102 to the second section 104, essentially reversing the process. As will be understood, there are several possible configurations where the first section 102 and the second section 104 may be connected. The set of locking dogs 124 may be operated by the downhole motor through a connected screw rod, as illustrated in FIG. 3. Alternate configurations are possible and are contemplated through this disclosure. Such alternate configurations include, for example, engaging/locking the first section 102 and the second section 104 through a variety of mechanical connections. These include collet fingers that are retained by a sleeve and systems using hydraulic actuation instead of a linear actuation by a motor. Such applications and methods may include a pre-charged tank and associated piping for movement of fluid to and from the connection, establishing actuation. In further embodiments, over-pressurization protection may be provided in such alternatives to prevent catastrophic destruction of hydraulic components when further movement of mechanical connectors is impossible due to jamming or other conditions. In all configurations described above, there may be a need for providing a “fine” adjustment for radial alignment of the first section 102 to the second section 104. In some embodiments, an arrangement to rotate either or both of the first section 102 to the second section 104 are provided. Such alignment may include a stabilizer on either or both of the first section 102 and the second section 104 and a motor or hydraulically actuated arrangement to perform rotation of the first section 102, the second section 104 or both. A monitoring system may be created, such as a pin/receptacle system that upon proper alignment, an electrical circuit is completed signaling a fine alignment has been performed and that the first section 102 and second section 104 are in position for connection. In embodiments, the pin (may be spring actuated) thereby indicating either a closed or open circuit, notifying the operator of alignment. In all embodiments, different types of connectors may be used, such as threaded or j-slot connections.

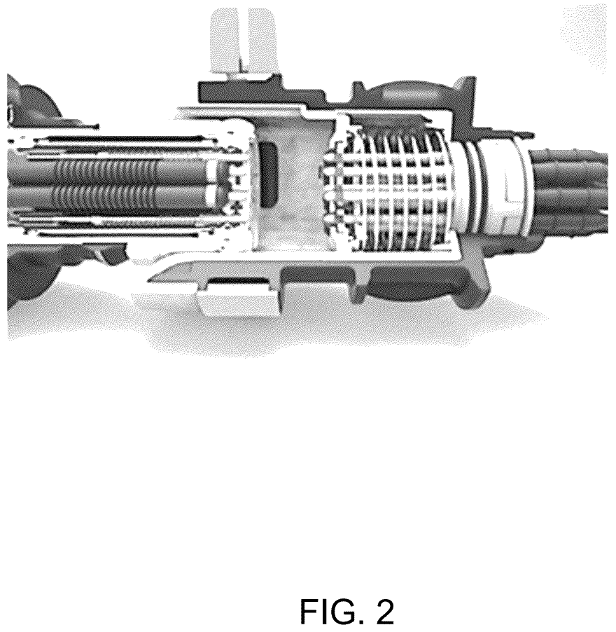

Referring to FIG. 2, a side view of the apparatus 100 is illustrated in an engaged position. Through this side view, a successful capture between the first end 102 and the second end 104 is illustrated.

The illustrated embodiments presented in FIGS. 1 to 3 represent one possible realization of the disclosed intervention tool wet connection apparatus. These FIGS. serve to clarify the inventive concept without limiting the scope of the disclosure to a single configuration. The detailed depictions highlight the apparatus's core features, which are designed to address the challenges of reliably connecting downhole and up-hole tools in wellbore environments. By referencing like elements across figures, the disclosure ensures consistency and facilitates a comprehensive understanding for engineers and technical reviewers.

Central to the improved electrical connection arrangement is the integration of controls within the up-hole section, which energize electrical components only upon confirmed engagement between the first and second sections. The use of an inner sleeve with a pin guide profile ensures precise alignment and mating of electrical contacts, further enhancing connection integrity. This deliberate arrangement prevents inadvertent power flow, thereby reducing the risk of short circuiting and potential tool damage. The system's design prioritizes reliability in challenging operational conditions, making it a significant advancement over conventional connection approaches.

The locking dogs mechanism, as illustrated, provides a secure and mechanically robust connection between the tool sections. Driven by a motor, the locking dogs transition from a disengaged to an engaged position, capturing the downhole tool within the up-hole section. This approach eliminates the need for excessive mechanical complexity while maintaining a high degree of connection security. The tangs of the locking dogs engage with corresponding recesses, ensuring that the connection is both firm and resistant to unintended separation.

Robustness and reliability are further emphasized by the apparatus's ability to prevent electrical engagement unless proper mechanical attachment is confirmed. This feature not only safeguards the electrical components but also minimizes the likelihood of operational failures. By avoiding intricate or convoluted designs, the disclosed system reduces the need for further intervention should attachment prove unsuccessful, streamlining field operations and enhancing overall efficiency.

The embodiments illustrated in FIGS. 1 to 3 exemplify an intervention tool connection apparatus that achieves a balance between secure mechanical engagement and reliable electrical connectivity. The use of locking dogs and a simplified electrical arrangement underscores the disclosure's commitment to robustness, operational simplicity, and reduced intervention requirements, making it a valuable contribution to downhole tool technology.

The embodiments described may be constructed from a variety of metallic materials chosen for their durability and resistance to harsh downhole conditions. Stainless steel is commonly selected due to its excellent corrosion resistance and mechanical strength, making it ideal for wet connection environments. Carbon steel is another suitable option, offering high toughness and cost-effectiveness, though it may require protective coatings to prevent corrosion. Additionally, other rugged alloys such as Inconel or titanium can be employed for enhanced performance in extreme temperatures or highly corrosive wells. The choice of material ensures reliability, longevity, and safety for wellbore intervention operations.

The intervention tool connection apparatus 100 described represents a significant advancement in downhole technology, prioritizing single failure proof design to ensure reliability and operational safety. In wellbore environments, where the consequences of a failed connection can be costly and dangerous, this apparatus integrates robust mechanical and electrical safeguards. By requiring confirmed engagement between tool sections before electrical activation, the system effectively prevents inadvertent power flow and mitigates the risk of short circuiting or tool damage. This deliberate arrangement means that engineers and wellbore operators can confidently identify the status of the connection, eliminating the need for guesswork and ensuring that the apparatus functions only when properly engaged.

The apparatus further enhances operational transparency by facilitating clear status identification. Features such as locking dogs, motor-driven engagement, and alignment pins allow operators to verify both mechanical and electrical connection integrity visually and electronically. This clarity is invaluable in high-pressure field operations, where quick and accurate assessments are essential for safe intervention.

Signal transmission from up-hole to downhole environments is accomplished via wireline technology, which enables real-time communication and control. The integration of inner sleeves and pin guide profiles ensures precise alignment for reliable signal flow, supporting advanced capabilities like remote actuation and monitoring. Operators can initiate tool functions and receive status updates from both wellside locations and centralized control rooms, empowering them to manage multiple wells simultaneously with a high degree of confidence.

The apparatus's 100 single failure proof design, combined with its status identification and remote control features, delivers enhanced operational efficiency and reliability. These innovations allow engineers and operators to streamline interventions, maximize safety, and maintain control across complex, multi-well environments.

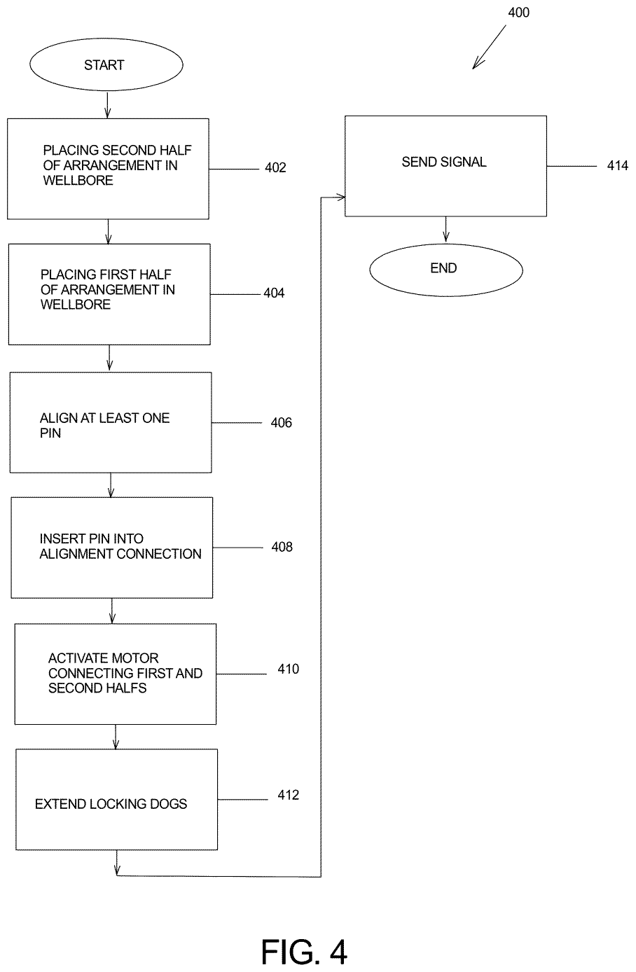

Referring to FIG. 4, one example embodiment of a method 400 is disclosed for connecting a first and second sections of an arrangement. Alterations from the method 400 are permitted such as altering the method 400 to meet differing configurations of the first section and second section configurations. For example, alignment of the first section and second section through use of an alignment pin can be performed with the alignment pin being located on either the first or second section. Other alterations are possible wherein motors that move locking dogs may be located on either side of the arrangement. In one embodiment, a method 400 for performing a wet connection in a downhole environment is presented. The method may include, at 402, placing a second half of an arrangement in the downhole environment. The method may further include, at 404, lowering a first half of the arrangement in the downhole environment. The method may further include, at 406, aligning at least one pin of at least one of the first half of the arrangement and the second half of the arrangement with an alignment connection. The method may further include, at 408, inserting the at least one pin into the alignment connection, wherein during the inserting pins from the second half of the arrangement are inserted into the first half of the arrangement and wherein an inner sleeve pin of the first half of the arrangement accepts the pins. The method may further include, at 410, activating a motor such that locking dogs connect the first half of the arrangement and the second half of the arrangement, wherein locking dog ends interface with a movable sleeve. The method may further include, at 412, extending the locking dogs from a disengaged position to an engaged position. The method may further include, at 414, sending a signal from the downhole environment to the up-hole environment that a successful connection has been established. The method may further include, at 406, activating a control unit such that electrical energy is transferred between the first half of the arrangement and the second half of the arrangement.

In the embodiments disclosed above, applications of the method and apparatus are used where a tool is placed in the downhole environment and operations are conducted to perform an intervention. Other scenarios are possible and contemplated for the apparatus with alternative methods. These include performing operations in the downhole environment where tools are intentionally left in the downhole environment for a period of time. The tools can then be intercepted and a wet tool connection established at a time in the future. Such contemplated operations can provide more flexibility in allowing other wellbore operations to be performed before establishing the wet connection.

Other possibilities of methods are also possible than those described above. For example, both the upper and lower sections may be placed in the wellbore. At a needed time, an alternate tool configuration may be used to establish a wet connection. In such an embodiment, differing types of tools may be configured together such that successive downhole investigations or operations can have different wellbore activities performed than possible with an original upper and lower sections originally used at the first placement.

Example embodiments of the claims are described next. The recitations below should not be considered limiting. In one example embodiment, a method for performing a wet connection in a downhole environment is disclosed. The method may comprise placing a second half of an arrangement in the downhole environment. The method may further comprise lowering a first half of the arrangement in the downhole environment. The method may further comprise aligning at least one pin of at least one of the first half of the arrangement and the second half of the arrangement with an alignment connection. The method may further comprise inserting the at least one pin into the alignment connection, wherein during the inserting pins from the second half of the arrangement are inserted into the first half of the arrangement and wherein an inner sleeve pin of the first half of the arrangement accepts the pins. The method may further comprise activating a motor such that locking dogs connect the first half of the arrangement and the second half of the arrangement, wherein locking dog ends interface with a movable sleeve. The method may further comprise activating a control unit such that electrical energy is transferred between the first half of the arrangement and the second half of the arrangement.

The method may further be performed wherein the alignment connection is located in the first half of the arrangement and the at least one pin is located in the second half of the arrangement.

The method may further be performed wherein the alignment connection is located in the first half of the arrangement and the at least one pin is located in the second half of the arrangement.

The method may further be performed wherein the electrical energy travels from an up-hole environment to the downhole environment.

The method may further be performed wherein the electrical energy travels from the downhole environment to the up-hole environment.

The method may further be performed wherein the electrical energy is supplied by at least one battery located in a wellbore.

The method may further be performed wherein the movable sleeve is located in the first section of the arrangement.

The method may further be performed wherein the locking dogs are operated by the through a connected screw rod.

The method may further comprise wherein after the activating of the motor, sending a signal from the downhole environment to the up-hole environment that a successful connection has been established.

The method may further be performed wherein the activating of the control unit is only performed after the signal has been received.

In another example embodiment, a method for performing a wet connection in a downhole environment is disclosed. The method may comprise placing a second half of an arrangement in the downhole environment. The method may further comprise lowering a first half of the arrangement in the downhole environment. The method may further comprise aligning at least one pin of at least one of the first half of the arrangement and the second half of the arrangement with an alignment connection. The method may further comprise inserting the at least one pin into the alignment connection, wherein during the inserting pins from the second half of the arrangement are inserted into the first half of the arrangement and wherein an inner sleeve pin of the first half of the arrangement accepts the pins. The method may further comprise activating a motor such that locking dogs connect the first half of the arrangement and the second half of the arrangement, wherein locking dog ends interface with a movable sleeve. The method may further comprise extending the locking dogs from a disengaged position to an engaged position. The method may further comprise sending a signal from the downhole environment to the up-hole environment that a successful connection has been established. The method may further comprise activating a control unit such that electrical energy is transferred between the first half of the arrangement and the second half of the arrangement.

The method may further be performed wherein the extending of the locking dogs places at least one tang of the locking dogs into a recess.

The method may further be performed wherein the electrical energy is supplied by at least one battery located in a wellbore.

The method may further be performed wherein the movable sleeve is located in the first section of the arrangement.

The method may further be performed wherein the movable sleeve is located in the first section of the arrangement.

The method may further be performed wherein the locking dogs are operated by the through a connected screw rod.

In another example embodiment, a connection for a downhole environment is disclosed. The connection comprises a first section having a first electrical socket. The connection further comprises a second section, having a motor and a set of latching dogs, the set of latching dogs configured to move from an engaged position to a disengaged position upon actuation by the motor, further having a collar that is configured to slide from a first position to a second position and a second electrical plug configured to engage with the first electrical socket to transfer electrical power through the connection.

In another example embodiment, the connection may further comprise a set of tangs connected to the set of latching dogs, the set of tangs configured to engage a set of recesses in the first section.

In another example embodiment, the connection may further comprise a tool make up connection arrangement configured within the first section.

In another example embodiment, the connection may further comprise a movable sleeve configured with a pin guide arrangement.

In another example embodiment, the connection may further comprise a fine radial alignment arrangement to rotate at least one of the first section and the second section, the fine radial alignment arrangement connected to at least one of the first and second section.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method for performing a wet connection in a downhole environment, comprising:
placing a second half of an arrangement in the downhole environment;
lowering a first half of the arrangement in the downhole environment;
aligning at least one pin of at least one of the first half of the arrangement and the second half of the arrangement with an alignment connection;
inserting the at least one pin into the alignment connection, wherein during the inserting pins from the second half of the arrangement are inserted into the first half of the arrangement and wherein an inner sleeve pin of the first half of the arrangement accepts the pins;
activating a motor such that locking dogs connect the first half of the arrangement and the second half of the arrangement, wherein locking dog ends interface with a movable sleeve; and
activating a control unit such that electrical energy is transferred between the first half of the arrangement and the second half of the arrangement.

2. The method according to claim 1, wherein the alignment connection is located in the first half of the arrangement and the at least one pin is located in the second half of the arrangement.

3. The method according to claim 1, wherein the alignment connection is located in the first half of the arrangement and the at least one pin is located in the second half of the arrangement.

4. The method according to claim 1, wherein the electrical energy travels from an up-hole environment to the downhole environment.

5. The method according to claim 1, wherein the electrical energy travels from the downhole environment to the up-hole environment.

6. The method according to claim 1, wherein the electrical energy is supplied by at least one battery located in a wellbore.

7. The method according to claim 1, wherein the movable sleeve is located in the first section of the arrangement.

8. The method according to claim 1, wherein the locking dogs are operated by the through a connected screw rod.

9. The method according to claim 1, further comprising wherein after the activating of the motor, sending a signal from the downhole environment to the up-hole environment that a successful connection has been established.

10. The method according to claim 9, wherein the activating of the control unit is only performed after the signal has been received.

11. A method for performing a wet connection in a downhole environment, comprising:
placing a second half of an arrangement in the downhole environment;
lowering a first half of the arrangement in the downhole environment;
aligning at least one pin of at least one of the first half of the arrangement and the second half of the arrangement with an alignment connection;
inserting the at least one pin into the alignment connection, wherein during the inserting pins from the second half of the arrangement are inserted into the first half of the arrangement and wherein an inner sleeve pin of the first half of the arrangement accepts the pins;
activating a motor such that locking dogs connect the first half of the arrangement and the second half of the arrangement, wherein locking dog ends interface with a movable sleeve;
extending the locking dogs from a disengaged position to an engaged position;
sending a signal from the downhole environment to the up-hole environment that a successful connection has been established; and
activating a control unit such that electrical energy is transferred between the first half of the arrangement and the second half of the arrangement.

12. The method according to claim 11, wherein the extending of the locking dogs places at least one tang of the locking dogs into a recess.

13. The method according to claim 11, wherein the electrical energy is supplied by at least one battery located in a wellbore.

14. The method according to claim 11, wherein the movable sleeve is located in the first section of the arrangement.

15. The method according to claim 11, wherein the movable sleeve is located in the first section of the arrangement.

16. The method according to claim 11, wherein the locking dogs are operated by the through a connected screw rod.

17. A connection for a downhole environment, comprising:
a first section having a first electrical socket; and
a second section, having a motor and a set of latching dogs, the set of latching dogs configured to move from an engaged position to a disengaged position upon actuation by the motor, further having a collar that is configured to slide from a first position to a second position and a second electrical plug configured to engage with the first electrical socket to transfer electrical power through the connection.

18. The connection according to claim 17, further comprising:
set of tangs connected to the set of latching dogs, the set of tangs configured to engage a set of recesses in the first section.

19. The connection arrangement according to claim 17, further comprising a tool make up connection arrangement configured within the first section.

20. The connection according to claim 17, further comprising:
a movable sleeve configured with a pin guide arrangement.

21. The connection according to claim 17 further comprising a fine radial alignment arrangement to rotate at least one of the first section and the second section, the fine radial alignment arrangement connected to at least one of the first and second section.
